(19) United States
(12) Patent Application Publication
(10) Pub. No.: US 2016/0036477 A1
(43) Pub. Date: Feb. 4, 2016

(54) ELECTRONIC DEVICE

(71) Applicant: Kabushiki Kaisha Toshiba, Tokyo (JP)

(72) Inventor: Masao Teshima, Kunitachi Tokyo (JP)

(21) Appl. No.: 14/671,884

(22) Filed: Mar. 27, 2015

Related U.S. Application Data
(60) Provisional application No. 62/030,424, filed on Jul. 29, 2014.

(51) Int. Cl. H04B 1/3877; H04B 1/3818

(52) U.S. Cl. CPC H04B 1/3877; H04B 1/3818

(57) ABSTRACT

According to one embodiment, an electronic device includes a housing, an antenna in a first position of the housing, and a wireless communication module in the housing, the wireless communication module performs wireless communication with an expansion device placed on the housing by using the antenna. The first position is set to such a position that a distance between a mounting surface of the expansion device and the antenna when the housing is placed on the mounting surface in the vertical orientation and a distance between the mounting surface and the antenna when the housing is placed on the mounting surface in the horizontal orientation are equal to each other.

### CROSS-REFERENCE TO RELATED APPLICATIONS

This application claims the benefit of U.S. Provisional Application No. 62/030,424, filed Jul. 29, 2014, the entire contents of which are incorporated herein by reference.

### FIELD

Embodiments described herein relate generally to an electronic device wirelessly connectable with an expansion device.

### BACKGROUND

Expansion devices are generally known as devices for making an electronic device such as a portable computer usable as a desktop computer. Such expansion devices are called docking stations (or port replicators).

Further, in recent years, handheld electronic devices such as tablet computers and PDAs have been developed, and the market thereof has been expanding.

Consequently, there is demand for expansion devices appropriate for electronic devices such as tablet computers and PDAs.

However, electronic devices such as tablet computers and PDAs are used in the horizontal orientation (landscape mode) and the vertical orientation (portrait mode). Therefore, there is a need for a technique to dock the electronic device and an expansion device easily regardless of the orientation (horizontal orientation or vertical orientation) of the electronic devices.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view of an external appearance of an electronic device of an embodiment.

FIG. 2 is an exemplary block diagram showing a structure of the electronic device of FIG. 1.

FIG. 3A and FIG. 3B are exemplary views of a state where the electronic device of FIG. 1 is placed on an expansion device (docking station) in the horizontal orientation.

FIG. 4A and FIG. 4B are exemplary view of a state where the electronic device of FIG. 1 is placed on an expansion device in the vertical orientation.

FIG. 5 is an exemplary block diagram showing a structure of an expansion device.

FIG. 6 is an exemplary view for explaining the position of an antenna in the electronic device of FIG. 1.

FIG. 7 is an exemplary view for explaining the position of an antenna in an expansion device.

FIG. 8A and FIG. 8B are exemplary views for showing the positional relationship between the antenna in the electronic device of FIG. 1 and the antenna of an expansion device in a case where the electronic device is placed on the expansion device in the horizontal orientation.

FIG. 9A and FIG. 9B are exemplary views for showing the positional relationship between the antenna in the electronic device of FIG. 1 and the antenna of an expansion device in a case where the electronic device is placed on the expansion device in the vertical orientation.

FIG. 10 is an exemplary view for explaining the position of the antenna in an expansion device.

### DETAILED DESCRIPTION

Various embodiments will be described hereinafter with reference to the accompanying drawings.

In general, according to one embodiment, an electronic device comprises a housing, an antenna in a first position of the housing, and a wireless communication module inside the housing. The wireless communication module performs, by using the antenna, wireless communication with an expansion device on which the housing is placed. The first position is set to such a position that the distance between the mounting surface and the antenna in a case where the housing is placed on the mounting surface of the expansion device in the vertical orientation and the distance between the mounting surface and the antenna in a case where the housing is placed on the mounting surface of the expansion device in the horizontal orientation are equal to each other.

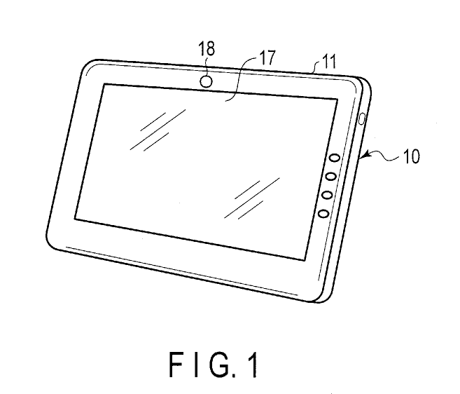

First, with reference to FIG. 1, the structure of the electronic device of the present embodiment will be described. The electronic device can be realized as a mobile device such as a tablet computer and a PDA. The following descriptions are given that the electronic device is realized as a tablet computer 10.

FIG. 1 illustrates an appearance of the tablet computer 10. The tablet computer 10 comprises a computer body 11, a touchscreen display 17, a camera 18 and the like. The computer body 11 comprises a thin box-shaped housing. The touchscreen display 17 is provided on the front surface of the computer body 11. The touchscreen display 17 comprises a flat panel display (such as a liquid crystal display [LCD]) and a touchpanel. The touchpanel is provided in such a manner as to cover the screen of the LCD. The touchpanel is configured to detect a position touched with the finger of the user or a stylus on the touchscreen display 17. The camera 18 is provided on the front surface of the computer body 11 in such a manner as to be located above the touchscreen display 17.

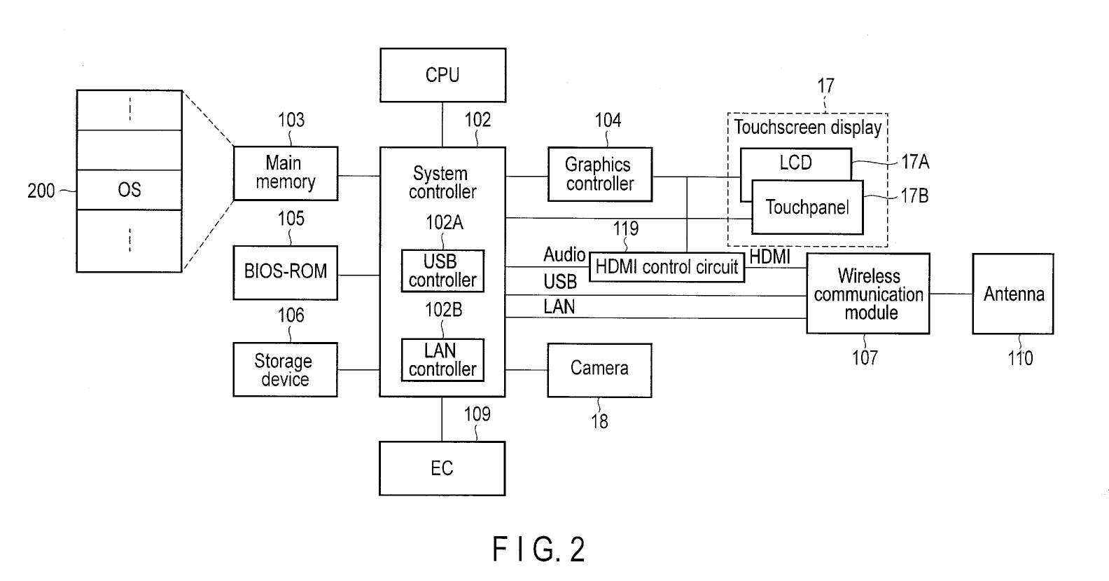

FIG. 2 is a block diagram showing the structure of the tablet computer 10.

The tablet computer 10 comprises, as shown in FIG. 2, a CPU 101, a system controller 102, a main memory 103, a graphics controller 104, a BIOS-ROM 105, a storage device 106, a wireless communication module 107, an embedded controller (EC) 109, an antenna 110, a High-definition Multimedia Interface (HDMI) control circuit 119 and the like in addition to the above described touchscreen display 17 and camera 18.

The CPU 101 is a processor configured to control the operations of various modules in the tablet computer 10. The CPU 101 executes various computer programs loaded from the storage device 106 such as a non-volatile memory into the main memory 103. These computer programs include an operating system (OS) 200 and various application programs.

Further, the CPU 101 executes a basic input/output system (BIOS) stored in the BIOS-ROM 105. The BIOS is a program for hardware control.

The system controller 102 is a device to connect a local bus of the CPU 101 and various components. The system controller 102 comprises a built-in memory controller configured to perform access control of the main memory 103. Further, the system controller 102 comprises a function of performing communication with the graphics controller 104 via a serial bus conforming to the PCI Express standard or the like. Still further, the system controller 102 comprises a built-in audio controller configured to generate a digital audio signal.

The graphics controller 104 is a display controller configured to control an LCD 17A used as a display monitor of the tablet computer 10. The display signal which the graphics controller 104 generates from display data is transmitted to the LCD 17A. The LCD 17A displays a screen image based on the display signal. On the LCD 17A, a touchpanel 17B is provided. The touchpanel 17B is a capacitive pointing device for performing input on the screen of the LCD 17A. A contact position touched with a finger on the screen, the movement of the contact position and the like are detected by the touchpanel 17B. Further, the graphics controller 104 can generate an HDMI video signal from the display data.

The HDMI control circuit 119 functions as an HDMI controller configured to generate a signal of the HDMI standard, which is obtained by superimposing the HDMI video signal and the digital audio signal.

The system controller 102 further comprises a USB controller 102A and a LAN controller 102B. The USB controller 102A is configured to perform communication conforming to the Universal Serial Bus (USB) standard. The LAN controller 102B is configured to perform communication conforming to the IEEE 802 (wired LAN) standard.

The wireless communication module 107 is a device configured to perform wireless communication conforming to a 60-GHz-band wireless communication standard such as WiGig (registered trademark). The wireless communication module 107 functions as a transceiver configured to perform, by using the antenna 110, wireless communication with an expansion device (docking station) which will be described later. The wireless communication between the wireless communication module 107 and the docking station is established for the peripheral interface controllers in the tablet computer 10 (here, the USB controller 102A, the LAN controller 102B, the HDMI control circuit 119 and the like) to control various peripheral devices connected to the docking station. That is, the signals transmitted and received between the peripheral controllers and the peripheral devices are wirelessly transmitted and received between the wireless communication module 107 and the docking station. For example, the wireless communication module 107 is configured to wirelessly transmit and receive the superimposed signal of a communication signal conforming to the HDMI standard, a communication signal conforming to the wired LAN standard and a communication signal conforming to the USB standard. The wireless communication module 107 modulates the superimposed signal and provides a high-frequency signal based on the modulated signal to the antenna 110. Further, the wireless communication module 107 demodulates the high-frequency signal which the antenna 110 received from the docking station and generates a digital signal. The wireless communication module 107 supplies a plurality of data streams contained in the digital signal to corresponding controllers (HDMI control circuit 119, USB controller 102A and LAN controller 102B), respectively.

The antenna 110 radiates (transmits) the high-frequency signal from the wireless communication module 107 into space as radio waves (electromagnetic waves). Further, the antenna 110 receives radio waves (electromagnetic waves) in space to be converted into a high-frequency signal. The high-frequency signal received by the antenna 110 is supplied to the wireless communication module 107. The signal transmitted and received by the wireless communication module 107 is, for example, a millimeter waveband signal (60-GHz band) with high directivity. The antenna 110 is provided inside the housing of the computer body 11. The antenna 110 may be provided on the back surface of the housing. The antenna 110 is provided on the back of the computer body 11 (on the side opposite to the touchscreen display 17) in such a manner that the radiation directivity of the antenna 110 is directed from the tablet computer 10 to the docking station when the tablet computer 10 is placed on the docking station. As described above, the signal transmitted and received by the wireless communication module 107 has high directivity. Therefore, the wireless communication module 107 wirelessly transmits and receives, by using the antenna 110, a signal having directivity extending in the direction perpendicular to the back surface of the housing. The size of the antenna 110 may be about 1 cm×1 cm.

The EC 109 is a single-chip microcomputer including an embedded controller for power control. The EC 109 comprises a function of powering on or powering off the tablet computer 10 based on an operation of a power button by the user.

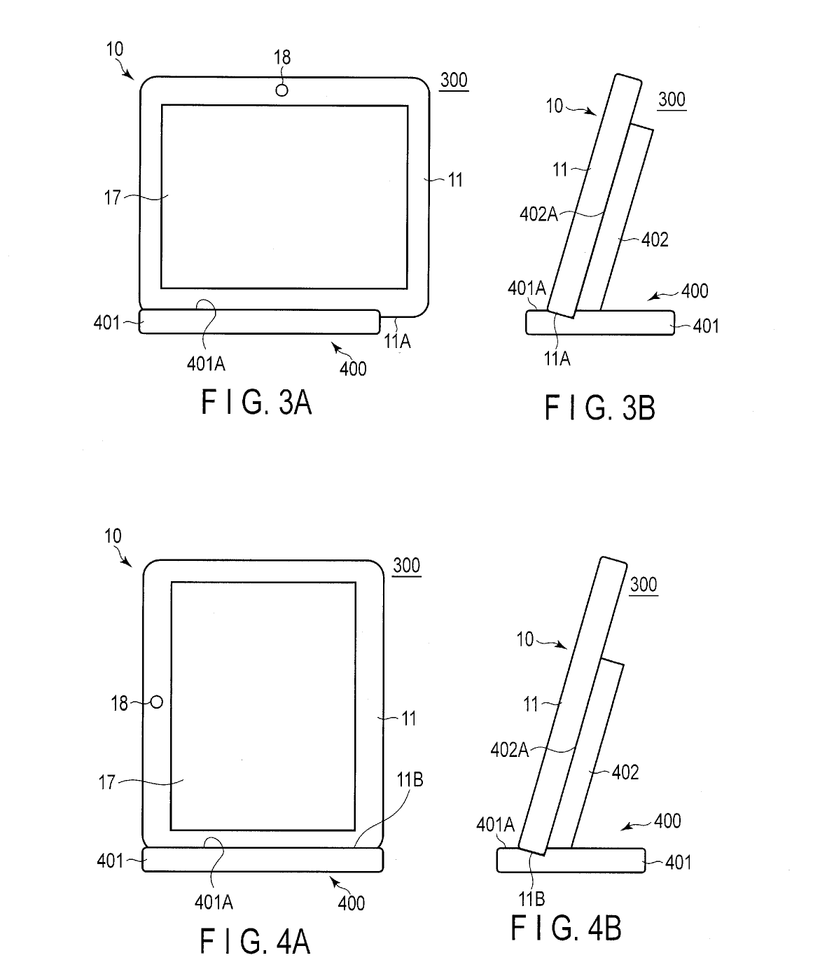

FIGS. 3A and 3B illustrate the relationship between the tablet computer 10 and an expansion device (docking station) 400. The docking station 400 functions as a wireless docking station configured to perform wireless communication with a computer placed on the docking station 400. The docking station 400 is a device for making the tablet computer 10 available as a desktop computer.

FIGS. 3A and 3B illustrate a state where the computer body 11 of the tablet computer 10 is placed on the housing of the docking station 400 in such a manner that the computer body 11 is in the horizontal orientation (landscape mode). The landscape mode is a style in which the tablet computer 10 is used in such a state where the screen of the touchscreen display 17 is in the horizontal orientation.

A system 300 includes the tablet computer 10 and the docking station 400. The tablet computer 10 can be placed on the docking station 400.

The docking station 400 comprises a housing including a mount 401 and a backrest (supporting member) 402 provided on the mount 401. The backrest (supporting member) 402 is a member for supporting the tablet computer 10 placed on the mount 401. The backrest 402 comprises a backrest surface (supporting surface) 402A. The angle between the backrest surface 402A and the upper surface (mounting surface) 401A of the mount 401 may be an obtuse angle. The housing of the docking station 400, for example, the mount 401 comprises a wireless communication module therein. The wireless communication module functions as a transceiver configured to perform wireless communication with the wireless communication module 107 inside the tablet computer 10.

When the computer body 11 is placed on the mounting surface 401A of the docking station 400 in the horizontal orientation, a first long side 11A of the computer body 11 contacts the mounting surface 401A and the back surface of the computer body 11 entirely or partially contacts the surface (backrest surface) 402A of the backrest 402.

FIGS. 4A and 4B illustrate a state where the computer body 11 of the tablet computer 10 is placed on the housing of the docking station 400 in such a manner that the body 11 is in the vertical orientation (portrait mode). The portrait mode is a style in which the tablet computer 10 is used in such a state where the screen of the touchscreen display 17 is in the vertical orientation.

When the computer body 11 is placed on the mounting surface 401A of the docking station 400 in the vertical orientation, the first short side 11B of the computer body 11 contacts the mounting surface 401A and the back surface of the computer body 11 entirely or partially contacts the backrest surface 402A of the backrest 402.

Regardless of whether the computer body 11 is placed on the mounting surface 401A of the docking station 400 in the horizontal orientation or the vertical orientation, the superimposed signal of a communication signal conforming to the HDMI standard, a communication signal conforming to the wired LAN standard and a communication signal conforming to the USB standard is wirelessly transmitted and received between the tablet computer 10 and the docking station 400.

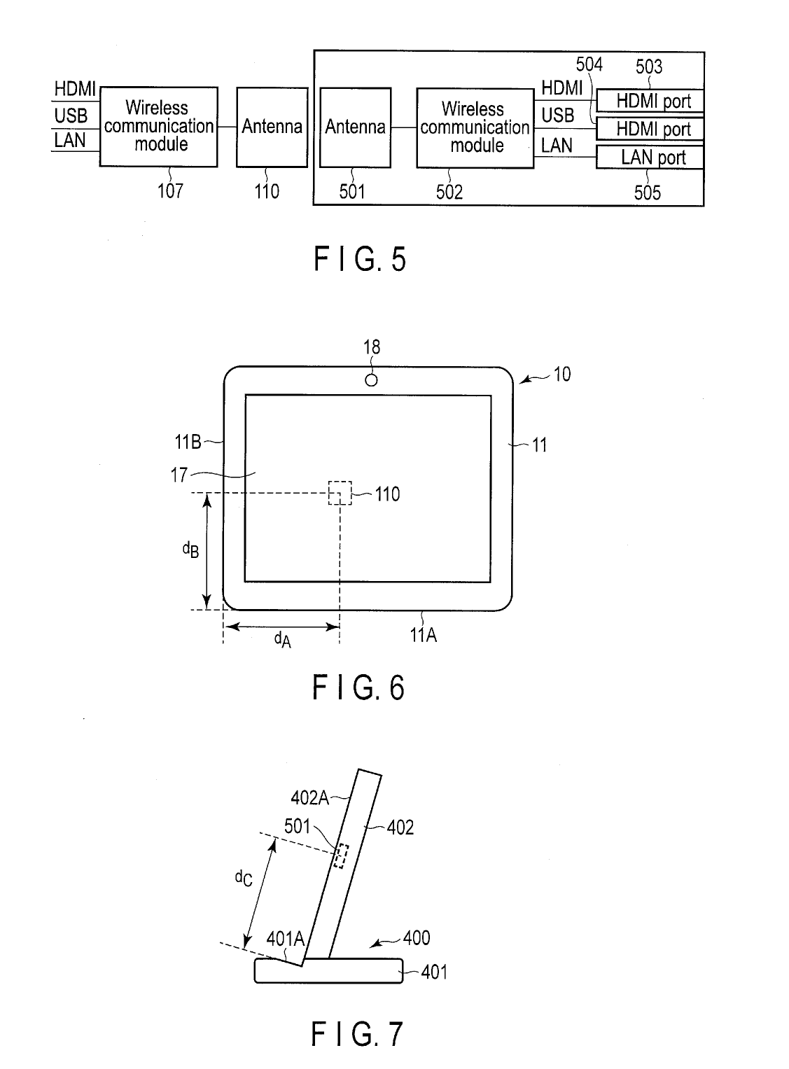

FIG. 5 is a block diagram showing a structure of the docking station 400.

The docking station 400 comprises an antenna 501, a wireless communication module 502, an HDMI port 503, a USB port 504, a LAN port 505 and the like. The HDMI port 503 is a connector for connecting an HDMI-compatible peripheral device (such as an external display monitor). The USB port 504 is a connector for connecting a USB-enabled peripheral device (USB device). The LAN port 505 is a connector for connecting a peripheral device (network device) via a LAN cable.

The antenna 501 is provided in the above-described backrest 402. The antenna 501 receives radio waves (electromagnetic waves) in space to be converted into a high-frequency signal. The high-frequency signal received by the antenna 501 is supplied to the wireless communication module 502. The wireless communication module 502 is a device configured to perform wireless communication conforming to a 60-GHz-band wireless communication standard such as WiGig (registered trademark). The wireless communication module 502 performs, by using the antenna 501, wireless communication with the wireless communication module 107 in the tablet computer 10. The radiation directivity of the antenna 501 on the side of the docking station 400 is set in such a manner as to be directed from the docking station 400 to the computer 10 when the tablet computer 10 is placed on the docking station 400.

The wireless communication module 502 demodulates the high-frequency signal received by the antenna 501 and generates a digital signal. The wireless communication module 502 supplies a plurality of digital data streams included in the digital signal to corresponding ports (HDMI port 503, USB port 504 and LAN port 505), respectively.

Further, the wireless communication module 502 modulates a superimposed signal of respective signals of the devices connected to the HDMI port 503, the USB port 504 and the LAN port 505, and provides a high-frequency signal based on the modulated signal to the antenna 501. The antenna 501 radiates (to transmit) the high-frequency signal supplied from the wireless communication module 502 as radio waves (electromagnetic waves) into space.

Next, the positions of the antenna 110 and 501 will be described. FIG. 6 is a view for explaining the position of the antenna 110 inside the computer body 11. FIG. 7 is a view for explaining the position of the antenna 501 inside the docking station 400.

As shown in FIG. 6, the computer body 11 comprises a first long side 11A and a first short side 11B. When the computer body 11 is placed on the mounting surface 401A of the docking station 400 in the horizontal orientation or the vertical orientation, the long side 11A or the short side 11B contacts the mounting surface 401A, and the back surface of the computer body 11 (surface on the side opposite to the touchscreen display 17) contacts the backrest surface 402A of the backrest 402.

In FIG. 6, a distance d_{A} is a distance between the mounting surface 401A and the antenna 110 when the computer body 11 is placed on the mounting surface 401A of the docking station 400 in the vertical orientation. Further, a distance d_{B} is a distance between the mounting surface 401A and the antenna 110 when the computer body 11 is placed on the mounting surface 401A of the docking station 400 in the horizontal orientation.

In the present embodiment, the antenna 110 is provided in such a position in the computer body 100 where distance d_{A} and distance d_{B} are equal to each other. More specifically, the first position is set to such a position where distance d_{A} between the mounting surface 401A and the antenna 110 when the computer body 11 is placed on the mounting surface 401A of the docking station 400 in the vertical orientation and distance d_{B} between the mounting surface 401A and the antenna 110 when the computer body 11 is placed on the mounting surface 401A of the docking station 400 in the horizontal orientation are equal to each other. In other words, the first position provided with the antenna 110 is such a position where the distance (distance d_{A}) between the first short side 11B and the antenna 110 and the distance (distance d_{B}) between the first long side 11A and the antenna 110 are equal to each other.

As a result, regardless of whether the computer body 11 is placed on the mounting surface 401A of the docking station in the vertical orientation or the horizontal orientation, the antenna 110 in the computer body 11 faces the same position on the backrest 402 of the docking station 400. Therefore, it is possible to establish wireless communication stably between the computer body 11 and the docking station 400 without providing an antenna in two places of the docking station 400.

If the antenna 110 is provided, for example, in the center of the region between the long side 11A and the touchscreen display 17, when the computer body 11 is placed on the mounting surface 401A in the horizontal orientation, the antenna 110 faces the center of the lower end of the backrest 402. On the other hand, when the computer body 11 is placed on the mounting surface 401A in the vertical orientation, the antenna 110 faces the right end of the backrest 402. In this way, the position in the backrest 402 facing the antenna changes based on the style of the computer body 11. In this case, the possible orientation of the computer body 11 to be placed on the mounting surface 401A is restricted to either one of the vertical orientation and the horizontal orientation. Otherwise, it is necessary to provide an antenna in two places on the backrest 402.

In the present embodiment, as described above, nevertheless of the orientation of the computer body 11, the antenna 110 in the computer body 11 always faces the same position on the backrest 402 of the docking station 400. Therefore, the orientation of the computer body 11 to be placed on the mounting surface 401A is not restricted, and thus it is possible to easily dock the tablet computer 10 and the docking station 400 wirelessly nevertheless of the orientation (horizontal orientation or vertical orientation) of the tablet computer 10.

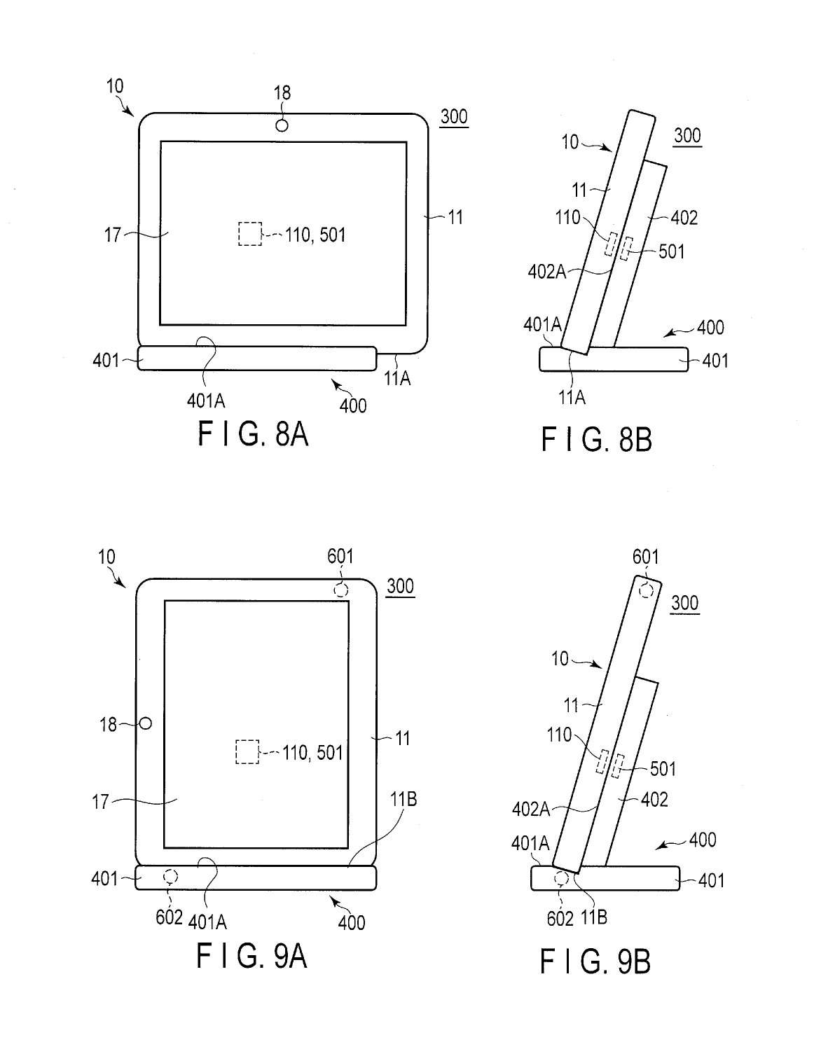

As shown in FIG. 7, in the docking station 400, the distance from the mounting surface 401A to the antenna 501 is set to a distance d_{C}. Distance d_{A}, distance dB and distance d_{C} are equal to one another. Since distance d_{A}, distance d_{B} and distance d_{C} are equal to one another, it is possible to make the antenna 110 and the antenna 501 facing each other simply by adjusting the position of the tablet computer 10 horizontally by hand in both cases where the tablet computer 10 is placed on the docking station 400 in such a manner that the touchscreen display 17 is in the horizontal orientation (landscape mode) (FIGS. 8A and 8B) and where the tablet computer 10 is placed on the docking station 400 in such a manner that the touchscreen display 17 is in the vertical orientation (portrait mode) (FIGS. 9A and 9B).

FIGS. 8A and 8B illustrate a state of the tablet computer 10 placed on the mounting surface 401A of the docking station 400 where the touchscreen display 17 is in the horizontal orientation. FIG. 8A illustrates a system 300 viewed from the front and FIG. 8B illustrates the system 300 viewed from the side. The antenna 501 on the side of the docking station 400 and the antenna 110 on the side of the tablet computer 10 face each other, and thus it is possible to stably perform wireless communication between the tablet computer 10 and the docking station 400.

FIGS. 9A and 9B show a case of the tablet computer 10 placed on the mounting surface 401A of the docking station 400 where the touchscreen display 17 is in the vertical orientation. FIG. 9A illustrates the system 300 viewed from the front and FIG. 9B illustrates the system 300 viewed from the side. When the tablet computer 10 is placed on the mounting surface 401A of the docking station 400 in the vertical orientation, the antenna 501 on the side of the docking station 400 and the antenna 110 on the side of the tablet computer 10 similarly face to each other, and thus it is possible to stably perform wireless communication between the tablet computer 10 and the docking station 400.

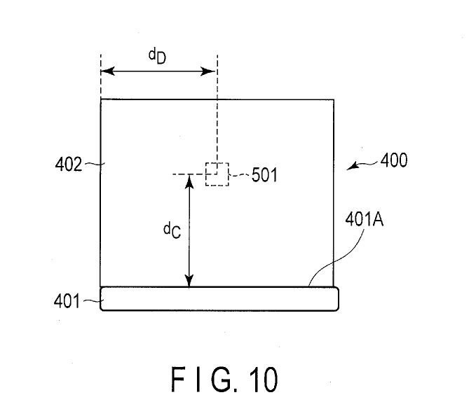

Note that, as shown in FIG. 10, in the docking station 400, it is preferable that a distance d_{D} from either one of the left and right sides of the backrest 402 to the antenna 501 be equal to the above-described distances d_{A}, d_{B} and d_{C}. In FIG. 10, a case where distance d_{D} is equal to distances d_{A}, d_{B} and d_{C} is illustrated. In this way, it is possible to easily make the antenna 501 on the side of the docking station 400 and the antenna 110 on the side of the tablet computer 10 facing each other simply by adjusting the position of the computer horizontally in such a manner as to align the left side of the computer body 10 placed on the mounting surface 401A and the left side of the backrest 402.

Note that, when the tablet computer 10 is used in the horizontal orientation, the user instinctively knows that the tablet computer 10 should be placed on the mounting surface 401A in such an orientation that the camera 18 is located above. However, when the tablet computer 10 is used in the vertical orientation, it is possible that the user does not know whether the tablet computer 10 should be placed on the mounting surface 401A in such a manner that the camera 18 is on the right side or on the left side. For this reason, as shown in FIGS. 9A and 9B, a magnetic sensor 601 may be provided inside the tablet computer 10, and in the mount 401, for example, on the mounting surface 401A, a magnet 602 may be provided. In FIGS. 9A and 9B, a case where the magnetic sensor 601 is provided in a position close to the upper edge of the short side 11 opposite to the short side 11B and the magnet 602 is provided in a position close to the left edge of the mounting surface 401A is illustrated. If the tablet computer 10 is placed on the mounting surface 401A in the vertical orientation incorrectly in such a manner that the camera 18 is located on the right side, the magnetic sensor 601 can detect magnetic force from the magnet 602. When magnetic force is detected by the magnetic sensor 601, a warning message warning that the tablet computer 10 is in the wrong orientation may be displayed on the touchscreen display 17. In this way, it is possible to have the user place the tablet computer 10 in the correct orientation again.

As described above, in the present embodiment, the position of the antenna 110 of the tablet computer 10 is set to such a position that the distance between the mounting surface 401A and the antenna 110 when the computer body 11 (housing) is placed on the mounting surface 401A of the docking station 400 in the vertical orientation and the distance between the mounting surface 401A and the antenna 110 when the computer body 11 is placed on the mounting surface 401A in the horizontal orientation are equal to each other. Therefore, when the tablet computer 10 is placed on the mounting surface 401A of the docking station in the vertical orientation or the horizontal orientation, in both cases, the antenna 110 faces the same position on the backrest 402 of the docking station 400. Consequently, it is possible to stably perform wireless communication between the tablet computer 10 and the docking station 400 without providing an antenna in two places of the docking station 400. Further, since wireless communication can be performed in such a manner that the antenna 110 and the antenna 501 of the docking station 400 face each other, high-speed data wireless data transmission using the signal of a millimeter waveband with high directivity becomes possible. This high-speed wireless data transmission makes it possible to perform a wireless transmission of, for example, a video signal or the like for displaying a high-definition screen image from the tablet computer 10 to the docking station 400.

As described above, in the present embodiment, it becomes possible to dock the tablet computer 10 and the docking station 400 without providing in the tablet computer 10 a connector intended exclusively for docking and nevertheless of the orientation (horizontal orientation or vertical orientation) of the tablet computer 10.

Note that, as the wireless communication method used for the wireless communication between the tablet computer 10 and the docking station 400, for example, short-range wireless communication, which can establish communication only about a few centimeters away, may be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a housing;
an antenna in a first position of the housing;
a wireless communication module in the housing, the wireless communication module configured to perform wireless communication with an expansion device placed on the housing by using the antenna, wherein
the first position is set to such a position that a distance between a mounting surface of the expansion device and the antenna when the housing is placed on the mounting surface in the vertical orientation and a distance between the mounting surface and the antenna when the housing is placed on the mounting surface in the horizontal orientation are equal to each other.

2. The device of claim 1, wherein the wireless communication module is configured to wirelessly transmit or received a signal with directivity extending in a direction perpendicular to a back surface of the housing by using the antenna.

3. The device of claim 1, wherein the first position is on a back surface of the housing.

4. The device of claim 1, further comprising a display on a front surface of the housing.

5. The device of claim 1, wherein the housing comprises a first short side and a first long side, and the first short side contacts the mounting surface and a back surface of the housing at least partially contacts a backrest of the expansion device when the housing is placed on the mounting surface in the vertical orientation.

6. The device of claim 1, further comprising one or more peripheral interface controllers in the housing, and wherein a signal transmitted and received between the one or more peripheral interface controllers and a peripheral device is wirelessly transmitted or received between the wireless communication module and the expansion device.

7. The device of claim 6, wherein the one or more peripheral interface controllers include at least one of a Universal Serial Bus (USB) controller, a LAN controller and a High-definition Multimedia Interface (HDMI) controller.

8. A system comprising:
an expansion device comprising a first housing comprising a mounting surface and a backrest, a first antenna in the backrest, and a first wireless communication module in the first housing, wherein a distance from the mounting surface to the first antenna is set to a first distance; and
an electronic device placeable on the mounting surface of the expansion device, the electronic device comprising:
a second housing;
a second antenna in a first position of the second housing; and
a second wireless communication module in the second housing, the second wireless communication module configured to perform wireless communication with the first wireless communication module of the expansion device by using the second antenna, wherein
the first position is set to such a position that a distance between the mounting surface and the second antenna when the second housing is placed on the mounting surface in the vertical orientation and a distance between the mounting surface and the second antenna when the second housing is placed on the mounting surface in the horizontal orientation are equal to the first distance.

9. The system of claim 8, wherein the second housing includes a first short side and a first long side, and the first short side contacts the mounting surface and a back surface of the second housing at least partially contacts the backrest when the second housing is placed on the mounting surface in the vertical orientation.
